(19) United States
(12) Patent Application Publication
(10) Pub. No.: US 2025/0337612 A1
(43) Pub. Date: Oct. 30, 2025

(54) SIMPLIFIED TIME DIVISION MULTIPLEXED ACCESS PHY FOR AN ETHERNET NETWORK

(71) Applicant: Microchip Technology Incorporated, Chandler, AZ (US)

(72) Inventors: Venkatraman Iyer, Austin, TX (US); Xin Zhang, Austin, TX (US)

(21) Appl. No.: 19/037,665

(22) Filed: Jan. 27, 2025

Related U.S. Application Data
(60) Provisional application No. 63/639,452, filed on Apr. 26, 2024.

(51) Int. Cl. H04L 12/40

(52) U.S. Cl. CPC H04L 12/40039; H04L 2012/40215; H04L 2012/40273

(57) ABSTRACT

Synchronization of data transmitted by controllers in an Ethernet multidrop network is controlled through a physical layer (PHY). A head unit of a network sends packets of data including masked fields to the PHY. A match on a data pattern of the masked field triggers the sampling of information at the same time from one or more banks of sensors and actuators. The sampled information is stored and synchronized for transmission back to the head unit via a time slot unique to each PHY based on a timeout delay of the pattern match trigger.

### CROSS-REFERENCE TO RELATED APPLICATIONS

This application claims the benefit under 35 U.S.C. § 119(e) of the priority date of U.S. Provisional Patent Application Ser. No. 63/639,452, filed Apr. 26, 2024, for “Simplified Time Division Multiplexed Access PHY for An Ethernet Network,” the contents and disclosure of which is incorporated herein in its entirety by this reference.

### BACKGROUND

Time division multiplexed access (TDMA) in an Ethernet network may be done by implementing an IEEE 1588 standard to perform time-synchronization within a network through use of a grandmaster clock. In one or more non-limiting examples, a network implementing the IEEE 1588 standard may include a grandmaster clock in a head unit of the network that may include a number of media access controllers (MACs). Each MAC in the network may control its own clock to be synchronized to the grandmaster clock during network data transmission. Each MAC may be configured to include hardware and/or software that synchronize to the grandmaster clock. The grandmaster clock may be synchronized to a time unit such as, for example, without limitation, an attosecond or a picosecond. Each time unit may be divided into slots. Each MAC clock may then be synchronized within the same time domain as the grandmaster clock which allows each MAC to have the same notion of time.

Each MAC may transmit data in a dedicated time slot that does not conflict with the time slot of another MAC. The IEEE 1588 standard with the use of a grandmaster clock and synchronization and calibration of the grandmaster clock within each MAC or other slave device in a network using may be hardware intensive and costly to implement.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagram that illustrates an apparatus in accordance with one or more examples;

FIG. 2 is a diagram that illustrates a system in accordance with one or more examples;

FIGS. 3A, 3B are flowcharts that illustrate a method of operating according to one or more examples;

FIG. 4 is a diagram that illustrates a multidrop system for synchronizing the transmission of data according to one or more examples; and

FIG. 5 is a block diagram of a system that may be used to implement one or more methods in accordance with one or more examples.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawing could be arranged and designed in a wide variety of different configurations. Thus, the following description of various embodiments is not intended to limit the scope of the present disclosure but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 50% met, at least 95% met, or even at least 99% met.

As used herein, any relational term, such as “over,” “under,” “on,” “underlying,” “upper,” “lower,” without limitation, is used for clarity and convenience in understanding the disclosure and accompanying drawings and does not connote or depend on any specific preference, orientation, or order, except where the context clearly indicates otherwise.

In this description the term “coupled,” and derivatives thereof, may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The term “connected” may be used in this description interchangeably with the term “coupled,” and has the same meaning unless expressly indicated otherwise or the context would indicate otherwise to a person having ordinary skill in the art.

An automotive Ethernet system may be based on an IEEE 802.3cg standard and may feature a number of devices connected via a 10BASE-T1S multidrop network. The system may include a number of external and interconnected elements, including, without limitation, sensors, actuators and modules connected through a physical layer (PHY) to a head unit. In this disclosure, for simplicity of reference, the external, interconnected elements will collectively be referred to as “sensors.” A head unit initiates a sampling of data from the sensors by sending a trigger pattern as part of a frame. A match on the trigger pattern is broadcast to one or more network controllers to initiate a capture or sampling, in a simultaneous manner, of respective sensor data by the network controllers. The data sampled or captured from each sensor is queued for transmission back to the head unit. The PHY synchronizes the transmission of the queued sampled sensor data using pre-assigned timeslots that are based on a delay timer initially activated by a match on the trigger pattern and configured to count from a predetermined threshold value to timeout before the data transmission from the queue to the head unit is enabled. It must be noted that although “simultaneous” is intended to indicate “at the same time,” the “same time” may on occasion be relative or subject to intrinsic or built-in delays caused by unequal distances from a head unit to a PHY or other destination or the movement of a signal through different transmission media.

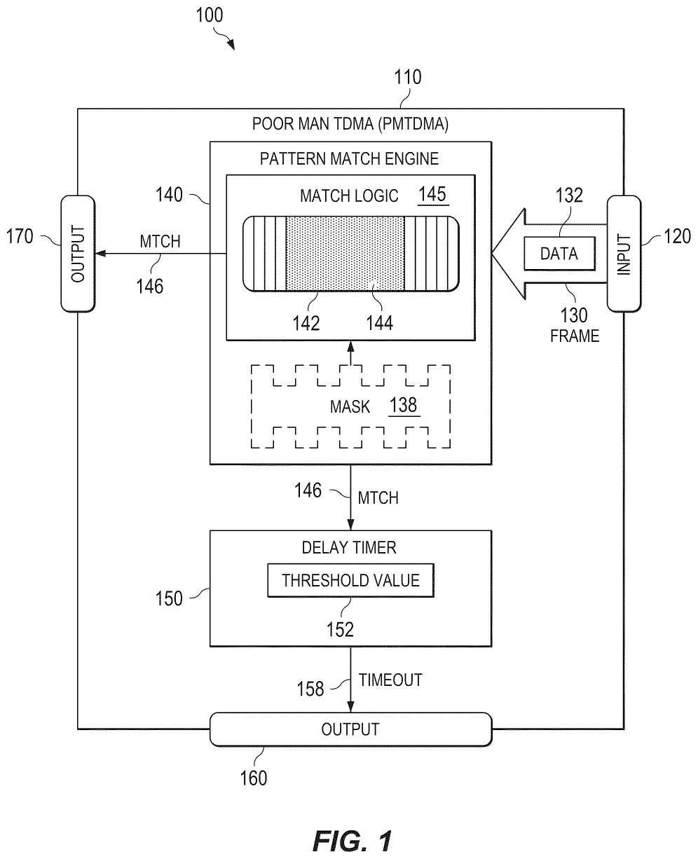

FIG. 1 is a block diagram that illustrates an apparatus in accordance with one or more examples of the disclosure. In FIG. 1, an apparatus 100 includes logic circuitry to implement a simplified time division multiplexed access (TDMA), referred to herein as a Poor Man TDMA (PMTDMA) 110, that synchronizes transmission of data from a plurality of devices in a multidrop network based on a trigger match on a portion of an input frame or packet. In one or more examples, the PMTDMA 110 may be implemented as part of a PHY (not shown). The PMTDMA 110 may include logic circuitry such as, without limitation, a pattern match engine 140 and in one or more examples, a timer, such as delay timer 150. The pattern match engine 140 of PMTDMA may include match logic 145 and a mask 138. Match logic 145 may include processing logic to extract data 132 from the input frame 130. In one or more examples, pattern match engine 140 may also include mask 138 logic.

It should be noted that the PMTDMA may be configured in different ways as would be recognized by one of ordinary skill in the art, For example, delay timer 150 may be located external to the PMTDMA 110.

In operation, PMTDMA 110 may receive a packet or frame 130 including packet data 132 through an INPUT 120 port to the pattern match engine 140. Pattern match engine 140 may include match logic 145 to extract a trigger packet 142 from the frame 130. A portion of the trigger packet 142 may include a maskable field or trigger pattern 144. Mask 138 may be applied to trigger packet 142 to exclude certain data bits to produce trigger pattern 144. Match logic may process the trigger packet 142 to determine whether the trigger pattern 144, which may be a portion of the trigger packet, matches a predetermined data pattern (not shown) stored at initialization in the pattern match engine 140. The trigger packet 142 may be processed in pattern match engine 140 by match logic 145 to determine whether a masked field 144 of trigger packet 142 matches the predetermined data pattern at a certain location within the trigger packet 142.

The masked field 144 may be formed within pattern match engine 140 through a mask 138 applied to the trigger packet 142 to exclude certain bits of trigger packet 142 from the matching process. The mask generates trigger pattern 144 which is a specific pattern in a specific location of the trigger packet 142. The trigger packet 142 may represent only a portion of the frame 130 input to the pattern match engine 140. For example, in one example, without limitation, the frame may have at least sixty bytes of information that includes headers, addresses including a data payload. A portion of the data payload may be a trigger packet 142. The trigger pattern 144, which is the maskable field, may only represent, for example, without limitation, 24 bits.

The pattern match engine 140 may be implemented by a hardware design, software design, or a combination of hardware and software designs such as a field-programmable gate array (FPGA). Although the pattern match engine 140 is illustrated as a single component, the pattern match engine 140 may be implemented by more than one component that may include one or more of memory, state machines, and other such elements as would be recognized by one of ordinary skill in the art. Additionally, although mask 138 is illustrated as part of the match logic 145 circuitry, it should be recognized that a mask operation may be programmed as part of a firmware initialization routine where the incoming frame data 132 already includes a predetermined pattern. The mask 138 may be configured as a series of individual ones and zeros and may operate to apply various patterns to frame data 132 such as, without limitation, an even pattern, an odd pattern to correspond with various sensor zones. The resulting trigger pattern 144 may be any number of bits arranged in a predetermined order as may be determined by the mask 138. The match logic 145 of pattern match engine 140 may be configured to monitor the incoming frames 130 of data 132 and search the data 132 for the trigger pattern 144. If the match logic 145 determines a match between the predetermined trigger pattern 144 and the input data frame 130, pattern match engine 140 may send a match signal, mtch 146, to the OUTPUT 170 port of the PMTDMA.

The match signal mtch 146 may be sent to the OUTPUT 170 of PMTDMA 110 for broadcast to external devices of a network in which PMTDMA 110 operates. The signal match 146 signal from OUTPUT 170 may be used by the external devices or sensors to initiate the sampling of sensor data at a same time. The match signal mtch 146 may also be used internally to the PMTDMA 110 to initiate a timer count. In one or more examples, a change of state of the internal signal mtch 146 activates a delay timer 150 to identify when to coordinate the transmission of data sampled from the sensors by one or more controllers to a head node.

Delay timer 150 may be preset to a threshold value 152. In one or more examples, threshold value 152 may be initially preset to a value that is equal to a node identification number (ID) number multiplied by a time that is required for normal transmission of a packet or frame 130 to a controller. The normal transmission time of a packet may be based on the size of the packet. The node ID may be an 8-bit numerical that is unique to each controller device.

In one or more examples of the disclosure, the generation of the match signal mtch 146 triggers the delay timer 150 to initiate a count starting from the preset threshold value 152. The delay timer 150 may be configured to count up or increment or count down or decrement from the initial preset threshold value 152. At the expiration of the delay timer 150, the delay timer 150 may send a signal, timeout 158, to an OUTPUT 160 port. As will be discussed later in this disclosure, the timeout 158 signal may be used to deassert a carrier signal to activate the transmission of data to the PHY.

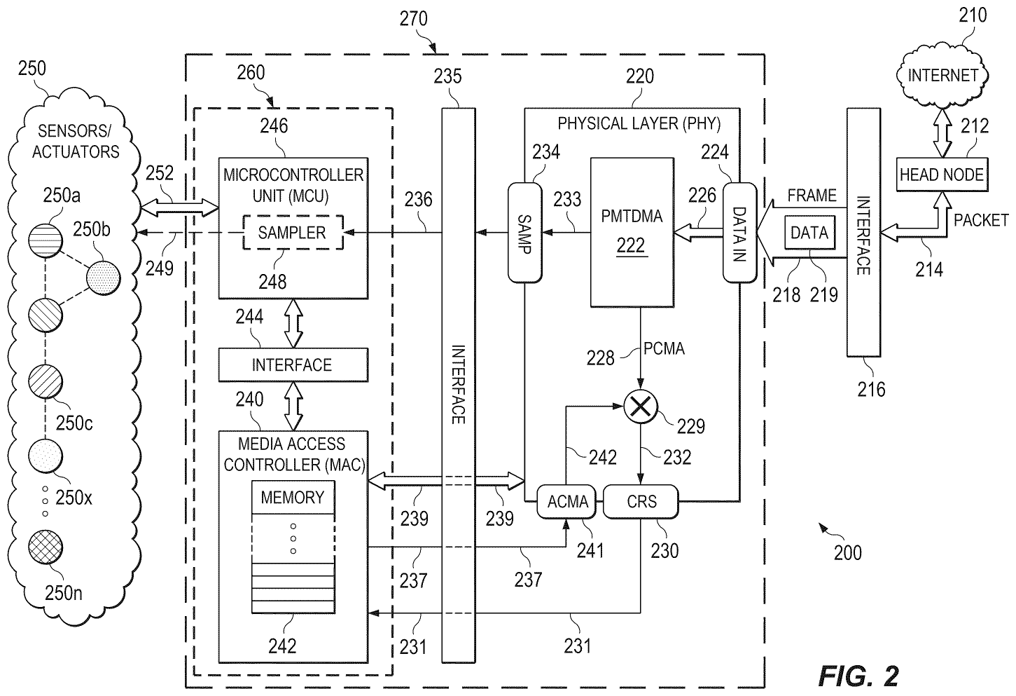

Turning to FIG. 2, a diagram illustrates an exemplary system 200 in accordance with one or more examples of the disclosure. System 200 illustrates a simplified multidrop network. It should be recognized that the multidrop network may be configured in various physical arrangements. For instance, in one or more examples, without limitation, the microcontroller unit (MCU) 246 may communicate through interface 244 with media access controller (MAC) 240 as part of a processing unit 260. Interface 244 may be a serial interface, such as, without limitation, an Inter-Integrated Circuit (I2C) interface. The processing unit 260 would interface with the PHY 220 through interface 235. Interface 235 may be configured as a media-independent interface (MII) in compliance with an IEEE standard. Alternatively, in one or more examples, the MAC 240, MCU 246 and the PHY 220 may be part of a System On Chip (SoC) 270. In the SoC 270 configuration, PHY 220 would operate as a digital controller. SoC 270 may interface with an analog transceiver portion of the PHY 220 that includes interface 216. Interface 216 may be a serial interface. These examples are not intended to be limiting. Other configurations may be possible as would be recognized by one of ordinary skill in the art.

A head node 212 of a network, such as, without limitation, network 210, may need to request information related to the value or state of one or more of the individual sensors/actuators or clusters or groups of sensors/actuators 250. In one or more examples, network 210 may be part of a vehicle or auto network. The sensors/actuators 250 group may comprise one or more sensor nodes such as 250a, 250b, 250c, 250n and/or one or more actuator nodes such as 250x. The nodes and/or actuators may be connected to one another based on a function, such as, without limitation, tire sensor, or location or zone, such as, without limitation, front bumper or rear bumper, or may represent stand-alone or individual elements.

The request from the head node 212 for information from one or more sensor/actuators 250 may begin when a packet 214 is sent from the network 210 over interface 216. The packet 214 may include a frame 218 with a payload of data 219 that may be masked to exclude or include certain bits in order to form a specific pattern of bits. It should be recognized that the frame 218 may comprise a portion of the packet or the entire packet. The IEEE standard specifies that a packet may be a minimum of 64 bytes which is 512 bits. The maskable field of the packet or frame 218 may be about 24 bits. The maskable field of 24 bits may be positioned starting at any bit or byte position within the frame. In one example, the mask may be programmed through firmware and applied to a field of the frame. In another example, the mask may be included as part of the hardware of the PMTDMA 222 such as mask 138 of FIG. 1. The packet or frame 218 may be input to a controller of the PHY 220 through an input port DATAIN 224. The PMTDMA 222 of the PHY may be configured to monitor the input data 226 of each incoming frame 218 for a match on the masked pattern or preprogrammed specific pattern of bits.

In one or more examples, a match between the preprogrammed pattern of bits in the PMTDMA and predetermined pattern and the programmed frame may cause the PMTDMA to output a trigger signal 233 to an output port SAMP 234 of the PHY 220 to initiate a sampling of data from sensors and/or actuators in a group of sensors/actuators 250. The output signal from SAMP 234 output 236 may be sent through an interface 235 to logic circuitry, such as, without limitation, sampler 248 of a microcontroller unit (MCU) 246. Sampler 248 may be configured to enable the MCU 246 to send an indicator 249 to select sensors/actuators 250 depending on the masked data pattern to initiate the sampling or capturing of data from one or more of the sensors/actuators. The MCU 246 may queue or store the sampled data 252 in memory. It must be noted that memory may be active or virtual memory of the MCU 246 or MAC 240. In one or more examples, the data 252 sampled from the sensors/actuators 250 may be queued in memory 242 of the MAC 240.

Returning to the operation of the PHY 220, a PHY controlled media access signal, PCMA 228, is output from PMTDMA 222 and asserted when an internal timeout signal triggered. PHY 220 may combine or group PCMA 228 at a junction 229 with an application controlled media access (ACMA) signal 242 input from an ACMA port 241 of the PHY 220 to drive a signal 232 to a carrier sense (CRS) output port 230 of the PHY 220. The CRS signal 231 is a backpressure signal used by the PHY 220 to control the flow of data from a receiving device through interface 235. The CRS signal 231 may be configured to be active or inactive when asserted. The release of the backpressure to the MAC 240 causes the MAC 240 to transmit a packet including the sensor data sampled from the sensors/actuators 250.

In one non-limiting example, when the CRS signal 231 is asserted, the backpressure to the MAC may be released to enable one or more packets 239 on sensor/actuator samples queued or stored in memory 242 to be transmitted over interface 235 through the PHY 220 to head node 212. In one or more examples of the disclosure, interface 235 may be a media-independent interface (MII) in accordance with an Ethernet standard.

In summary, a signal 232 may be output from the CRS output port 230 upon a timeout indication that the PHY 220 is ready to receive transmissions of data from sensor/actuators 250. The PCMA 228 signal may be asserted when the count of a delay timer internal to the PMTDMA 222 of PHY 220, such as delay timer 150 of FIG. 1, expires indicates timeout. In one or more examples, the delay timer may be located external to the PHY 220, such as, for example without limitation, within processing unit 260 or within SoC 270. A timeout indicator signal internal to the PHY may drive the PCMA 228 signal. A timeout indicator signal external to the PHY, timeout 237, may drive an application controlled Media Access (ACMA) signal 242 through ACMA port 241. The ACMA signal 242 may synchronize with or replace the PCMA 228 signal through junction 229 and drive signal 232 to the CRS output port 230, to cause CRS signal 231 to be asserted to release the backpressure to the MAC 240. As stated previously, the release of the backpressure to the MAC 240 causes the MAC 240 to transmit data to the PHY.

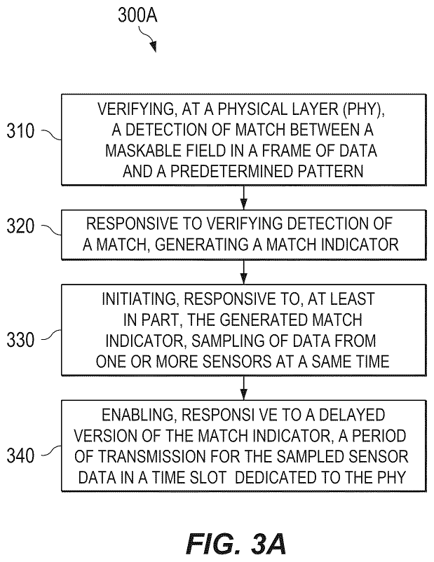

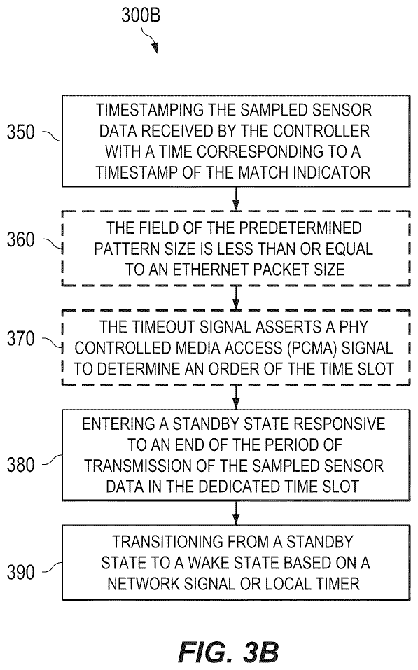

FIGS. 3A, 3B are flowcharts that illustrate a method of operating according to one or more examples. In FIG. 3A, process 300A at a block 310, may verify at a physical layer (PHY), a detection of match between a maskable field in the frame of data and a predetermined pattern. At a block 320, responsive to verifying detection of a match, a match indicator may be generated. In one or more examples, the match indicator may be a pulse. In one or more examples, the match indicator may be a level signal. At a block 330, the sampling of data from one or more sensors at a same time, or simultaneously, may be initiated responsive to the generated match indicator. At a block 340, the process may enable, responsive to a delayed match indicator, a period of transmission for the sampled sensor data in a time slot dedicated to the PHY.

Proceeding next to FIG. 3B, in process 300B at block 350, the sampled sensor data received by the controller may be timestamped with a time corresponding to a timestamp of the match indicator. The match indicator signals that a match exists between a predetermined mask pattern and a field of a portion of incoming frame data. It should be recognized that the match indicator may be configured as any type of signal that indicates a change of state such as, without limitation, a pulse signal or a level signal.

At block 360, it is recognized that the field of the predetermined pattern may have a size that is less than or equal to an Ethernet packet size. At a block 370, the timeout signal asserts a PHY controlled media access (PCMA) 228 signal which determines the start of a transmission of the sampled sensor data in a time slot shared by one or more PHY. The order of transmission of data from each PHY in the time slot is thus determined, at least in part, by the timing of assertion of the PCMA signal.

At block 380, the PHY may enter a standby state responsive to an end of the period of transmission of the sampled sensor data in the dedicated time slot. The system may enter a standby state to save power. At block 390, the PHY may transition from a standby state to a wake state based on, for example, without limitation, a network signal or a local source, such as a timer. The transition from a standby state may occur when the head node 212 is prepared to send another request to sample data. In one or more examples, the local source may be a wake-up signal or wake trigger sent by the head node 212 after a predetermined time set by a timer prior to preparing or sending a trigger packet. The local source may also be a software command to wake up the node. In one or examples, the network signal may be, for example, without limitation, a remote wake-up signal coming from the network, for example, without limitation, a wake on Local Area network (Wake-on-LAN) network message to turn on or return a node or system to processing.

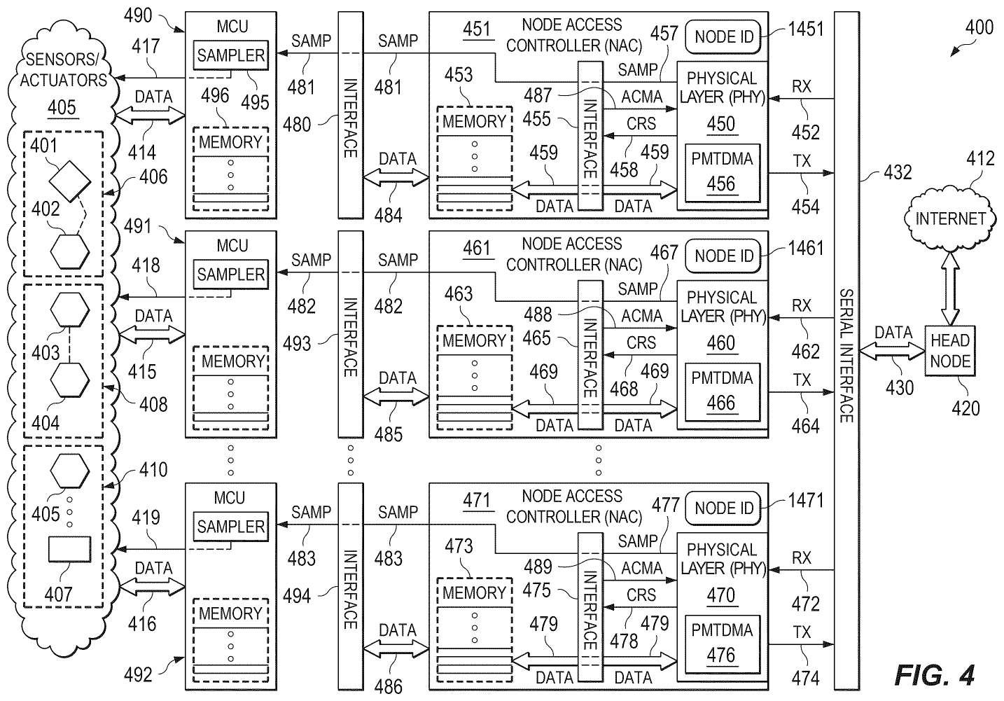

Turning to FIG. 4, a block diagram that illustrates a multidrop 10BASE-T1S system 400 for synchronizing the transmission of data in a network according to one or more examples. The multidrop system 400 may include a number of node access controllers (NACs), that represent nodes on a shared bus or serial interface 432. In one or more non-limiting examples, a number of NACs such as NAC 451, NAC 461, and NAC 471 may be coupled to respective MCUs, such as MCU 490, MCU 491 and MCU 492. As illustrated, the network may be configured with a NAC on a separate device from the MCU. However, it should be recognized that, as discussed above in FIG. 2, a number of network configurations are possible. For example, without limitation, a NAC, such as NAC 451, and MCU, such as MCU 490 may form a single processing unit, such as processing unit 260 of FIG. 2.

A head unit or node 420 of an automotive system may have the ability to establish a connection to the internet or network 412 for a variety of reasons including, for example, without limitation, global positioning system (GPS) tracking and diagnostics. The head node 420 refers to a node that may be programmed to include more processing capabilities than any other node to manage or keep track of time on a network. Head node 420 may be a large compute unit such as, with limitation, a switch or a processor. The term “head” as used herein, implies superiority in processing power or management capability within a network. In one or more automotive network examples, the head node 420 may be located anywhere within the system, such as, without limitation, an automobile truck, glove compartment, dashboard, or other location depending on automobile design, as would be recognized by one of ordinary skill in the art.

The head node 420 recognizes each NAC in the network by a unique identifier (ID) or node ID. For example, without limitation, NAC 451 may have a node ID 1451, NAC 461 may have a node ID 1461, and NAC 471 may have a node ID 1471. Each NAC in the system may control access to a shared serial interface 432. A transceiver (not shown) may use serial interface 432 to receive and send data 430 over designated transmit (TX) and receive (RX) connections. Each NAC may receive and transmit data over respective TX and RX connections. For example, without limitation, NAC 451 may have connections RX 452 and TX 454; NAC 461 may include connections RX 462 and TX 464, and NAC 471 may have connections RX 472 and TX 474. The voltages and currents of the TX and RX connections may be controlled through the transceiver (not shown).

The head node 420 may be configured to send a trigger packet of data 430 over serial interface 432 to a number of node access controllers (NACs) in order to request information from a group of sensors/actuators 405. The sensors/actuators 405 may be configured as multiple zones, such as, without limitation, a zone 406, a zone 408 and a zone 410. Each zone may be located at different locations within an automobile network. For example, without limitation, zones may include a front bumper, a rear bumper side doors, wheels, front and/or rear brakes. One or more sensors, such as sensor 401, sensor 403, sensor 404, and sensors/actuators 405, and one or more actuators, such as actuator 402 and actuator 407 may be connected within a zone or may be a standalone or individual sensor.

The trigger packet of data 430 may be time-stamped by the head node 420 based on a network clock (not shown) such as the IEEE 1588 master clock. In one or more examples, the head unit or head node 420 may send a trigger packet of data 430 to request or sample information from the sensors/actuators 405. Application software, such as firmware, may determine the configuration of a trigger packet and whether or not a trigger package may be sent. The trigger packet may be transmitted over a serial interface 432 which is connected to one or more NACs, such as NAC 451, NAC 461, and NAC 471. For example, without limitation, In the illustrated example, NAC 451, NAC 461 and NAC 471 may all simultaneously monitor the packets sent over the serial interface 432. Each NAC may include a dedicated PHY. NAC 451 may include PHY 450; NAC 461 may include PHY 460, and NAC 471 may include PHY 470. PHY 450, PHY 460, and PHY 470 may each include a poor man time decision multiplexed access (PMTDMA) logic circuitry that generates a trigger match signal when a field of the trigger packet matches a predetermined data pattern. In the illustrated example, PHY 450 includes PMTDMA 456 to generate trigger match, samp 457, PHY 460 include PMTDMA 466 to generate samp 467 and PHY 470 include PMTDMA 476 to generate samp 477. Samp signals 457, 467, and 477 may be output from each respective NAC as samp signal 481, 482, and 483.

NAC 451, NAC 461 and NAC 471 may output samp signals 481, 482, and 483, respectively, to MCU 490, MCU 491 and MCU 492. MCU 490, MCU 491, and MCU 492 may each respectively include sampling circuitry such as sampler 495 of MCU 490 to initialize a sampling signal, such as sampler signal 417, to sample data from the sensors/actuators 405. Sampler signal 417, sampler signal 418 and sampler signal 419 each initiate the sampling of data 414, 415, and 416, respectively, from sensors/actuator 405 in zone 406, zone 408, and zone 410 at the same time, or simultaneously, based on the initialization of the sampler signals 417, 418 and 419.

The sampled data 414, 415, 416 received from each respective zone 406, 408, and 410 of sensors/actuator may be queued or stored in a memory corresponding to each NAC. The memory may be part of an MCU, such as, for example, without limitation, memory 496 of MCU 490. The memory may also be internal to each NAC, for example, without limitation, memory 453 which corresponds to NAC 451, memory 463 which corresponds to NAC 461 or memory 473 which corresponds to NAC 471. NACs 451, 461, and 471 may also transfer incoming sampled data 484, 485, and 486 across interfaces 480, 493, and 494, to be stored or queued in memory 453, 463, and 473, respectively.

For purposes of simplicity, the operations internal to the NAC after the PHY triggers a match and the samp signal enables the queuing of sampler data in memory is now described with respect to NAC 451. But it should be noted that the operation of the NAC 451 is exemplary of the other NACs of the network, including without limitation NAC 461 and NAC 471.

The samp signals 481, 482, and 483 signals are output based on a trigger match in respective NAC 451, NAC 461, and NAC 471 to indicate to the groupings of sensors/actuators that sensor data must be retrieved. Internal to each PHY, such as PHY 450, 460, and 470, the match trigger may initiate a time delay count of a delay timer (not shown). In NAC 451, the time delay count may be initially set to a threshold determined by a unique Node ID 1451 and a preprogrammed transmit time. Upon expiration of the time delay count, the PHY 450 may deactivate a carrier sense signal, CRS 458, which when active prevents the transmission of data across serial interface 432. The CRS 458 may determine whether or not data 459 is transmitted over the interface 455 through the PHY 450. The deactivation of the CRS 458 signal releases the back pressure to the PHY and causes data 459 queued or stored in memory 453 or memory 496 to be transmitted in a time slot at a dedicated time to the PHY 450 in a serial manner over TX 454 to the requesting head node 420 for further processing.

The other NACs connected in the network may operate in a similar manner as NAC 451 to transfer sensor data requested from the head node 420 in the same time slot by at a different time. The timing of the transfer of data in the shared time may be staggered or multiplexed among NAC of the network based on the timer threshold logic of each PMTDMA of each PHY. The timer threshold logic is based on the unique ID assigned to each NAC and a packet transmission time. Thus, each NAC on the network is enabled by the deactivation of the CRS signal to transmit data within a unique timeframe or timeslot that is synchronized to the expiration of a count of a delay timer.

For example, CRS 468 of NAC 461 may be activated by a timeout from PMTDMA 466. The active CRS 468 releases the backpressure on interface 465 to enable sensor data from sensors/actuators 405 that may be stored in memory, such as memory 463, to transmit data 469 in the shared timeslot shared by all the NAC to the head node 420. Similarly, CRS 478 of NAC 471 may be activated by a timeout from PMTDMA 476. The active CRS 478 releases the backpressure on interface 475 to enable sensor data from sensors/actuators 405 that may be stored in memory, such as memory 473, to transmit data 479 in the shared timeslot shared by all the NACs of system 400 to the head node 420.

In one or more examples, the NACs may include a delay timer, such as delay timer 150 of FIG. 1, that is external to the PMTDMA of a PHY, such as PHY 450, PHY 460, and PHY 470. The timeout of the external delay timer will drive an application controlled media access (ACMA) signal to the PHY. For example, ACMA 487 will drive PHY 450, ACMA 488 will drive PHY 460 and ACMA 489 will drive PHY 470. The ACMA signals input to each respective PHY may synchronize with an internal signal of the PHY at a junction, such as junction 229 of FIG. 2, to drive the CRS output signal that releases the backpressure of an interface to enable the transmission of stored sensor data. In one non-limiting example, ACMA signal 487 when active will activate CRS 458 to transmit sampled sensor data 459 during a predetermined time slot or time period dedicated to the transmission from NAC 451. In one non-limiting example, ACMA signal 488 when active will activate CRS 468 to transmit sampled sensor data 469 during a predetermined time slot dedicated to the transmission from NAC 461. In one non-limiting example, ACMA 489 when active will activate CRS 478 to transmit sampled sensor data 479 during a predetermined time slot dedicated to the transmission from NAC 471. NAC 451, NAC 461 and NAC 471 may only transmit data in a period of time or timeslot determined by the delay timer threshold count expiration. When the delay timer is external to the PHY, the ACMA signal is input to the PHY and used, in part, to synchronize the CRS output signal of the PHY that controls the timing of transmission of sensor data of a node to the head node. When the delay timer is internal to the PHY, the PCMA signal, such as PCMA 228 of FIG. 2, is used in part to synchronize the CRS output signal of the PHY that controls the timing of transmission of sensor data of a node to the head node.

It will be appreciated by those of ordinary skill in the art that functional elements of examples disclosed herein (e.g., functions, operations, acts, processes, or methods) may be implemented in any suitable hardware, software, firmware, or combinations thereof. FIG. 9 illustrates non-limiting examples of implementations of functional elements disclosed herein. In some examples, some or all portions of the functional elements disclosed herein may be performed by hardware specially configured for carrying out the functional elements.

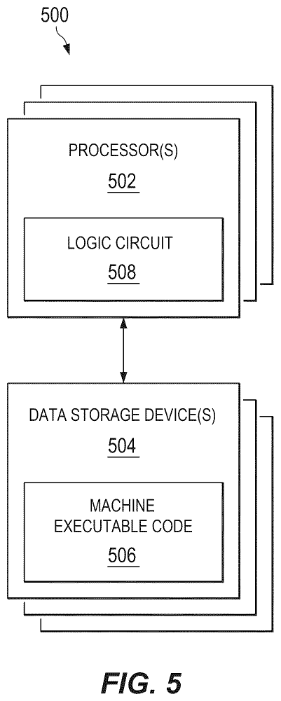

FIG. 5 is a block diagram of a system 500 that may be used to implement one or more methods in accordance with one or more examples. The system 500, in some examples, may be used to implement various functions, operations, acts, processes, or methods disclosed herein. The system 500 includes one or more processors 502 (sometimes referred to herein as “processors 502”) operably coupled to one or more data storage devices 504 (sometimes referred to herein as “storage 504”). The storage 504 includes machine executable code 506 stored thereon and the processors 502 include logic circuit 508. The machine executable code 506 information describing functional elements that may be implemented by (e.g., performed by) the logic circuit 508. The logic circuit 508 is adapted to implement (e.g., perform) the functional elements described by the machine executable code 506. The system 500, when executing the functional elements described by the machine executable code 506, should be considered as special purpose hardware configured for carrying out functional elements disclosed herein. In some examples, the processors 502 may be configured to perform the functional elements described by the machine executable code 506 sequentially, concurrently (e.g., on one or more different hardware platforms), or in one or more parallel process streams.

When implemented by logic circuit 508 of the processors 502, the machine executable code 506 is configured to adapt the processors 502 to perform operations of examples disclosed herein. By way of non-limiting example, the machine executable code 506 may be configured to adapt the processors 502 to perform some or a totality of operations of one or more of scrambling code word tables and encoding drive signals utilizing scrambled code word tables.

Also by way of non-limiting example, the machine executable code 506 may be configured to adapt the processors 502 to perform some or a totality of features, functions, or operations disclosed herein. The processors 502 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute functional elements corresponding to the machine executable code 506 (e.g., software code, firmware code, hardware descriptions) related to examples of the present disclosure. It is noted that a general-purpose processor (may also be referred to herein as a host processor or simply a host) may be a microprocessor, but in the alternative, the processors 502 may include any conventional processor, controller, microcontroller, or state machine. The processors 502 may also be implemented as a combination of computing devices, such as a combination of a DSP and a microprocessor, a plurality of microprocessors, one or more microprocessors in conjunction with a DSP core, or any other such configuration.

In some examples, the storage 504 includes volatile data storage (e.g., random-access memory (RAM)), non-volatile data storage (e.g., Flash memory, a hard disc drive, a solid state drive, erasable programmable read-only memory (EPROM), without limitation). In some examples, the processors 502 and the storage 504 may be implemented into a single device (e.g., a semiconductor device product, a system on chip (SOC), without limitation). In some examples, the processors 502 and the storage 504 may be implemented into separate devices.

In some examples, the machine executable code 506 may include computer-readable instructions (e.g., software code, firmware code). By way of non-limiting example, the computer-readable instructions may be stored by the storage 504, accessed directly by the processors 502, and executed by the processors 502 using at least the logic circuit 508. Also by way of non-limiting example, the computer-readable instructions may be stored on the storage 504, transferred to a memory device (not shown) for execution, and executed by the processors 502 using at least the logic circuit 508. Accordingly, in some examples, the logic circuit 508 includes electrically configurable logic circuit 508.

In some examples, the machine executable code 506 may describe hardware (e.g., circuitry) to be implemented in the logic circuit 508 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, System Verilog or very large scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 508 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples, the machine executable code 506 may include an HDL, an RTL, a GL description, a mask level description, other hardware description, or any combination thereof.

In examples where the machine executable code 506 includes a hardware description (at any level of abstraction), a system (not shown, but including the storage 504) may be configured to implement the hardware description described by the machine executable code 506. By way of non-limiting example, the processors 502 may include a programmable logic device (e.g., an FPGA or a PLC) and the logic circuit 508 may be electrically controlled to implement circuitry corresponding to the hardware description into the logic circuit 508. Also by way of non-limiting example, the logic circuit 508 may include hard-wired logic manufactured by a manufacturing system (not shown, but including the storage 504) according to the hardware description of the machine executable code 506.

Regardless of whether the machine executable code 506 includes computer-readable instructions or a hardware description, the logic circuit 508 is adapted to perform the functional elements described by the machine executable code 506 when implementing the functional elements of the machine executable code 506. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means “some or a totality.” As used herein, the term “each and every” means a “totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples of the disclosure include:

Example 1: An apparatus of a multidrop network, comprising: a pattern match engine to detect a predetermined pattern in a trigger packet, and, at least in part in response to detection of the predetermined pattern in the trigger packet, generate a trigger signal; sampling circuitry to sample sensor data from one or more sensors in a 10BASE-T1S network responsive, at least in part, to the trigger signal; and logic circuitry to enable a period of transmission on the 10BASE-T1S network for the sampled sensor data in a time slot dedicated to a physical layer (PHY) device, wherein the period of transmission is triggered based, at least in part, on a delay initiated by the trigger signal.

Example 2: The apparatus according to Example 1, wherein the logic circuitry, comprises: a delay circuit to delay propagation of the trigger signal based on a predetermined amount of time and ending at a timeout.

Example 3: The apparatus according to any of Examples 1 and 2, wherein a duration of the predetermined amount of time is defined by n*m, where n is a node identification number of the PHY device and m is a time required for transmission of the trigger packet.

Example 4: The apparatus according to any of Examples 1 through 3, wherein the sampling circuitry stores collected sensor data in a queue for transmission to the PHY device.

Example 5: The apparatus according to any of Examples 1 through 4, wherein the delay circuit comprises a timer to, responsive, at least in part, to the trigger signal generated by the pattern match engine, initiate a count and generate a delayed trigger signal at the timeout.

Example 6: The apparatus according to any of Examples 1 through 5, wherein the logic circuitry to, responsive, at least in part, to the delayed trigger signal, enable transmission of queued sensor data in the time slot dedicated to the PHY device.

Example 7: The apparatus according to any of Examples 1 through 6, wherein the PHY device asserts a PHY controlled media access (PCMA) signal responsive to the timeout to control a start of a transmission time slot.

Example 8: The apparatus according to any of Examples 1 through 7, wherein the transmission time slot is interleaved with one or more PHY in the multidrop network.

Example 9: The apparatus according to any of Examples 1 through 8, wherein the PHY device to assert a carrier sense (CRS) signal to an interface responsive to the PCMA signal, to enable the period of transmission.

Example 10: The apparatus according to any of Examples 1 through 9, wherein the pattern match engine comprises a mask to create the predetermined pattern.

Example 11: A system for a 10BASE-T1S Ethernet network, comprising: a number of data acquisition systems connected by an unsynchronized multidrop bus; a plurality of node access controllers to control respective connections between the number of data acquisition systems and the multidrop bus, wherein respective node access controllers to: detect a trigger packet received via the multidrop bus; initiate sampling of sensor data by a respective data acquisition system responsive, at least in part, to the detected trigger packet; determine a time slot dedicated to a physical layer (PHY) of a respective node access controller based, at least in part, on the detected trigger packet; and enable a period of transmission for the sampled sensor data in the determined time slot.

Example 12: The system according to Example 11, wherein the PHY comprises: a pattern match engine to, based on a comparison of the trigger packet with a pattern mask, trigger a signal indicating a match on a predetermined pattern; and a timer to, responsive to the match, initiate a count starting at a value preset to n*m, where n is a node identification (ID) number of each PHY device and m is a time required for transmission of the trigger packet.

Example 13: The system according to any of Examples 11 and 12, comprising sampling circuitry to, responsive to the trigger match, sample sensor data from one or more sensors in a 10BASE-T1S network and queue the sampled sensor data in the node access controller.

Example 14: The system according to any of Examples 11 through 13, wherein an expiration of the count deasserts a carrier sense (CRS) output from the PHY to enable transmission of queued sensor data across an interface in a predetermined time slot.

Example 15: The system according to any of Examples 11 through 14, wherein the trigger packet comprises a timestamp, based on the trigger match, to associate with the sampled sensor data.

Example 16: A method in a multidrop Ethernet network, comprising: detecting, at a physical layer (PHY) of a respective node access controller (NAC), a match between a trigger packet of data and a predetermined pattern; responsive to the detection of match, generating a match indicator; initiating responsive to, at least in part, the generated match indicator, a sampling of data from one or more sensors at a same time; and enabling, responsive to a delayed version of the match indicator, a period of transmission for the sampled sensor data in a time slot dedicated to the PHY.

Example 17: The method according to Example 16, wherein the generated match indicator initiates a count starting from a predetermined value preset to n multiplied by m to a timeout, where n is a node identification (ID) number of each PHY and m is a time required for transmission of the trigger packet based on a size of an input frame.

Example 18: The method according to any of Examples 16 and 17, comprising timestamping the sampled sensor data received by a controller with a time corresponding to a timestamp of the match indicator.

Example 19: The method according to any of Examples 16 through 18, wherein a field of the predetermined pattern is less than or equal to a size of an Ethernet packet.

Example 20: The method according to any of Examples 16 through 19, wherein a timeout signal asserts an PHY controlled media access (PCMA) signal to determine an order of the time slot.

Example 21: The method according to any of Examples 16 through 20, comprising: entering a standby state responsive to the transmission of a time division multiplexed sensor data; and transitioning from a standby state to a wake state based on one of a wake signal from a network and a local timer.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

One or more implementations have been described herein. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated as may be determined by this disclosure or from any additional disclosure of the attached.

What is claimed is:

1. An apparatus of a multidrop network, comprising:
a pattern match engine to detect a predetermined pattern in a trigger packet, and, at least in part in response to detection of the predetermined pattern in the trigger packet, generate a trigger signal;
sampling circuitry to sample sensor data from one or more sensors in a 10BASE-T1S network responsive, at least in part, to the trigger signal; and
logic circuitry to enable a period of transmission on the 10BASE-T1S network for the sampled sensor data in a time slot dedicated to a physical layer (PHY) device, wherein the period of transmission is triggered based, at least in part, on a delay initiated by the trigger signal.

2. The apparatus of claim 1, wherein the logic circuitry, comprises:
a delay circuit to delay propagation of the trigger signal based on a predetermined amount of time and ending at a timeout.

3. The apparatus of claim 2, wherein a duration of the predetermined amount of time is defined by n*m, where n is a node identification number of the PHY device and m is a time required for transmission of the trigger packet.

4. The apparatus of claim 2, wherein the sampling circuitry stores collected sensor data in a queue for transmission to the PHY device.

5. The apparatus of claim 4, wherein the delay circuit comprises a timer to, responsive, at least in part, to the trigger signal generated by the pattern match engine, initiate a count and generate a delayed trigger signal at the timeout.

6. The apparatus of claim 5, wherein the logic circuitry to, responsive, at least in part, to the delayed trigger signal, enable transmission of queued sensor data in the time slot dedicated to the PHY device.

7. The apparatus of claim 6, wherein the PHY device asserts a PHY controlled media access (PCMA) signal responsive to the timeout to control a start of a transmission time slot.

8. The apparatus of claim 7, wherein the transmission time slot is interleaved with one or more PHY in the multidrop network.

9. The apparatus of claim 7, wherein the PHY device to assert a carrier sense (CRS) signal to an interface responsive to the PCMA signal, to enable the period of transmission.

10. The apparatus of claim 1, wherein the pattern match engine comprises a mask to create the predetermined pattern.

11. A system for a 10BASE-T1S Ethernet network, comprising:
a number of data acquisition systems connected by an unsynchronized multidrop bus;
a plurality of node access controllers to control respective connections between the number of data acquisition systems and the multidrop bus, wherein respective node access controllers to:
detect a trigger packet received via the multidrop bus;
initiate sampling of sensor data by a respective data acquisition system responsive, at least in part, to the detected trigger packet;
determine a time slot dedicated to a physical layer (PHY) of a respective node access controller based, at least in part, on the detected trigger packet; and
enable a period of transmission for the sampled sensor data in the determined time slot.

12. The system of claim 11, wherein the PHY comprises:
a pattern match engine to, based on a comparison of the trigger packet with a pattern mask, trigger a signal indicating a match on a predetermined pattern; and
a timer to, responsive to the match, initiate a count starting at a value preset to n*m, where n is a node identification (ID) number of each PHY device and m is a time required for transmission of the trigger packet.

13. The system of claim 12, comprising sampling circuitry to, responsive to the trigger match, sample sensor data from one or more sensors in a 10BASE-T1S network and queue the sampled sensor data in the node access controller.

14. The system of claim 13, wherein an expiration of the count deasserts a carrier sense (CRS) output from the PHY to enable transmission of queued sensor data across an interface in a predetermined time slot.

15. The system of claim 14, wherein the trigger packet comprises a timestamp, based on the trigger match, to associate with the sampled sensor data.

16. A method in a multidrop Ethernet network, comprising:
detecting, at a physical layer (PHY) of a respective node access controller (NAC), a match between a trigger packet of data and a predetermined pattern;
responsive to the detection of match, generating a match indicator;
initiating responsive to, at least in part, the generated match indicator, a sampling of data from one or more sensors at a same time; and
enabling, responsive to a delayed version of the match indicator, a period of transmission for the sampled sensor data in a time slot dedicated to the PHY.

17. The method of claim 16, wherein the generated match indicator initiates a count starting from a predetermined value preset to n multiplied by m to a timeout, where n is a node identification (ID) number of each PHY and m is a time required for transmission of the trigger packet based on a size of an input frame.

18. The method of claim 17, comprising timestamping the sampled sensor data received by a controller with a time corresponding to a timestamp of the match indicator.

19. The method of claim 18, wherein a field of the predetermined pattern is less than or equal to a size of an Ethernet packet.

20. The method of claim 19, wherein a timeout signal asserts an PHY controlled media access (PCMA) signal to determine an order of the time slot.

21. The method of claim 16, comprising:
entering a standby state responsive to the transmission of a time division multiplexed sensor data; and
transitioning from a standby state to a wake state based on one of a wake signal from a network and a local timer.
